(19) United States
(12) Patent Application Publication
(10) Pub. No.: US 2014/0002655 A1
(43) Pub. Date: Jan. 2, 2014

(54) LANE DEPARTURE WARNING SYSTEM AND LANE DEPARTURE WARNING METHOD

(71) Applicant: LG Innotek Co., Ltd., Seoul (KR)

(72) Inventors: Jeong Woo WOO, Seoul (KR); Ki Dae KIM, Seoul (KR); Babu MANOHAR, Seoul (KR); Raghubansh B. GUPTA, Seoul (KR)

(21) Appl. No.: 13/932,139

(22) Filed: Jul. 1, 2013

(30) Foreign Application Priority Data
Jun. 29, 2012 (KR) 10-2012-0071225

(51) Int. Cl. G08G 1/16

(52) U.S. Cl. CPC G08G 1/167
USPC 348/148

(57) ABSTRACT

Disclosed are a lane departure warning system and a lane departure warning method. The lane departure warning system includes an image photographing unit attached to a front of a vehicle to photograph an object in a forward direction of the vehicle; a driving unit that receives image data from the image photographing unit to search for a lane pair by filtering the image data using a predetermined mask, and calculates a time of lane change from the lane pair to the vehicle to generate a warning generating signal; and a warning unit receiving the warning generating signal to generate a lane departure warning signal.

### CROSS-REFERENCE TO RELATED APPLICATION

This application claims the benefit under 35 U.S.C. §119 of Korean Patent Application No. 10-2012-0071225, filed Jun. 29, 2012, which is hereby incorporated by reference in its entirety.

### BACKGROUND

The embodiment relates to a lane departure warning system and a lane departure warning method.

In general, traffic accident inhibiting technologies are mainly focused on vehicle collision inhibiting technologies.

A technology dedicated for a single vehicle predicts collision between vehicles using information sensed from various sensors.

Further, a technology based on cooperation between vehicles senses collision between the vehicles by collecting various information from peripheral vehicles or an infrastructure system using a communication technology such as dedicated short-range communications (DRSC).

However, the traffic accident inhibiting technology according to the related art predicts traffic accident using locations, speed, and direction information of vehicles in cooperation with a vehicle system or receives traffic information from peripheral vehicles or an infrastructure system using a communication technology.

Accordingly, an interworking system is required between a warning system and a vehicle, and data may be polluted due to an erroneous operation of some system.

### BRIEF SUMMARY

The embodiment provides a warning system capable of inhibiting accident by warning an unexpected lane departure of a vehicle in a single system without cooperation with a vehicle system.

According to the embodiment, there is provided a lane departure warning system including an image photographing unit attached to a front of a vehicle to photograph an object in a forward direction of the vehicle; a driving unit that receives image data from the image photographing unit to search for a lane pair by filtering the image data using a predetermined mask, and calculates a time of lane change from the lane pair to the vehicle to generate a warning generating signal; and a warning unit receiving the warning generating signal to generate a lane departure warning signal.

The driving unit includes a preprocessing unit filtering the image data to extract candidate lane regions, and grouping the candidate lane regions based on features of the extracted candidate lane regions; a lane searching unit searching for a lane pair from the grouped candidate lane regions from the preprocessing unit; and a warning generating unit to calculate the time of lane change between the lane and the vehicle based on the lane pair in order to generate the warning generating signal.

The driving unit further includes a lane tracking unit to track a current lane pair based on the lane pair of previous image data.

The preprocessing unit selects a region of interest having a predetermined size from the image data to process data of the selected region of interest.

The preprocessing unit places the mask to a left and a right of a corresponding pixel of pixels in the region of interest to extract pixels in the mask as the candidate lane region when the pixels have an average data value greater than a threshold value.

A size of the mask is variable.

The size of the mask is increased along a vertical axis of the region of interest.

The preprocessing unit compares a gradient, a bottom intersection point and a top intersection point of the candidate lane region with each other to group a plurality of candidate lane regions.

The preprocessing unit enhances the image data in the region of interest to emphasize the feature.

The enhancement of the image data is performed by applying a CLAHE algorithm.

The lane searching unit acquires the lane pair by searching for the lane pair, and calculates a curvature of the lane pair to store curve data.

The lane tracking unit acquires the lane pair by estimating the lane pair when the lane region group does not exist.

Further, according to the embodiment, there is provided a lane departure warning method including photographing an object in a forward direction of a vehicle to generate image data; selecting a lane region group by dividing the image data using a predetermined mask and filtering the divided image data; searching for a lane pair in the lane region group; tracking the lane pair in a current frame based on the lane pair when the lane pair exists in the lane region group; and generating a warning signal according to a time of lane change by calculating the time of lane change from the lane pair to the vehicle.

The selecting of the lane region group includes selecting a region of interest having a predetermined size from the image data; extracting pixels having an average data value greater than a threshold value in the mask as the candidate lane region by placing the mask to a left and a right of a corresponding pixel of pixels in the region of interest; and generating the lane region group by grouping the candidate lane region based on a feature of the candidate lane region.

The feature of the candidate lane region includes a gradient, a bottom intersection point and a top intersection point.

The candidate lane region is generated by varying a size of the mask.

The extracting of the candidate lane region further includes enhancing the image data of the region of interest.

The searching of the lane pair includes selecting the lane pair by comparing information about features of the lane region group with each other; acquiring the lane pair by comparing the selected lane pairs with lane pairs of previous frames; and storing curve data by calculating a curvature of the lane pair.

The tracking of the lane pair includes acquiring the lane pair by estimating the lane pair when the lane region group does not exist.

The region of interest in the tracking of the lane pair has a size less than a size of the region of interest in the searching of the lane pair.

According to the embodiment, the functions of searching for and tracking a vehicle are proposed for and introduced to the system, so that the system can simply warn the lane departure of a vehicle.

That is, when the lane feature is extracted by extracting the region of interest from the image, the searching unit and the tracking unit have mutually different regions of interest, so that the speed of the system can be increased, the system can be used even if the lane is one or more, and the lane can be searched regardless of external environment.

### BRIEF DESCRIPTION OF THE DRAWINGS

FIG. 1 is a block diagram showing a configuration of a lane departure warning system according to the embodiment;

FIG. 2 is a flowchart illustrating an operation of the lane departure warning system shown in FIG. 1;

FIG. 3 is a flowchart illustrating an image preprocessing step of FIG. 2 in detail;

FIG. 4 is a photographic view illustrating an image representing a region of interest (ROI) of FIG. 3;

FIG. 5 is a flowchart illustrating a lane searching step of FIG. 2 in detail;

FIG. 6 is a flowchart illustrating a lane tracking step of FIG. 2 in detail;

FIG. 7 is a photographic view illustrating an image representing an ROI of the lane tracking step; and

FIG. 8 is a flowchart illustrating a warning generating step in detail.

### DETAILED DESCRIPTION

Hereinafter, embodiments will be described in detail with reference to accompanying drawings so that those skilled in the art can easily work with the embodiments. However, the embodiments may not be limited to those described below, but have various modifications.

In the following description, when a predetermined part “includes” a predetermined component, the predetermined part does not exclude other components, but may further include other components unless indicated otherwise.

The embodiment provides a system which may be mounted on a vehicle to warn of an abrupt lane departure of the vehicle while the vehicle is moving.

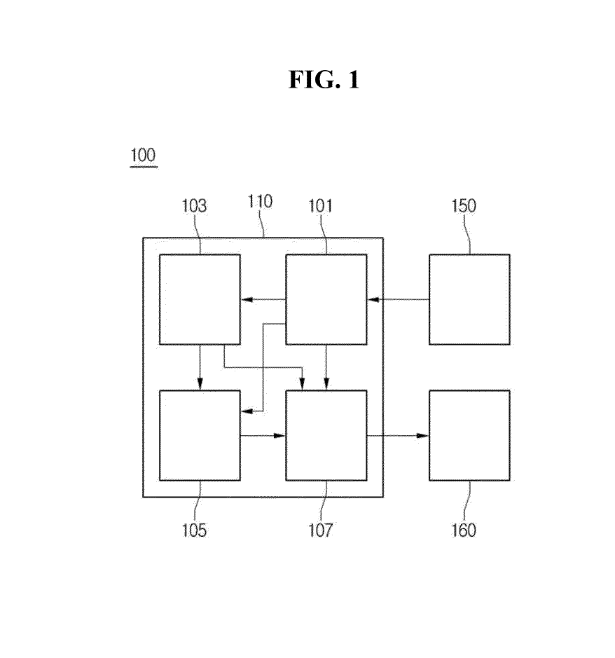

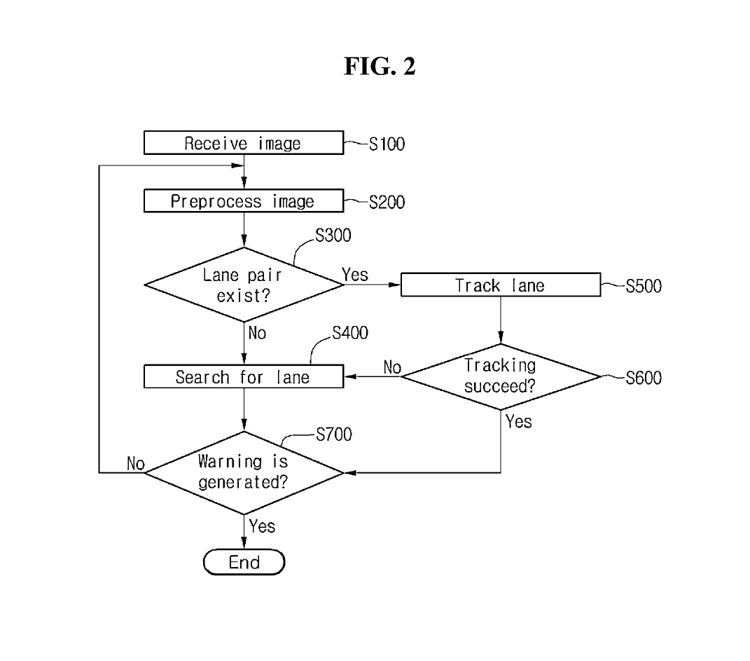

Hereinafter, a lane departure warning system will be described with FIGS. 1 and 2.

FIG. 1 is a view showing a system configuration according to the embodiment and FIG. 2 is a flowchart illustrating an operation of the system depicted in FIG. 1.

Referring to FIG. 1, the lane departure warning system includes an image photographing unit 150, a warning unit 160 and a driving unit 110.

The image photographing unit 150 includes a camera photographing a subject at a predetermined frequency, in which the camera photographs a front of a vehicle and transfers a photographed image to the driving unit 110.

In this case, the image photographing unit 150 may include an infrared camera which may operate at night, and may be operated by controlling a lighting system according to external environment.

The warning unit 160 receives a warning generating signal from the driving unit 110 and provides a lane departure warning signal to a driver.

In this case, the warning signal may include an audible signal such as alarm. In addition, the warning signal may include a visible signal displayed in a navigation device of the vehicle.

The driving unit 110 receives image data photographed by the image photographing unit 150 in units of frame (S100). The driving unit 110 detects a lane from the received image data, calculates a lateral distance between the lane and the vehicle, and then, calculates elapsed time until lane departure based on the lateral distance. When the elapsed time is in a predetermined range, the driving unit 110 generates the warning generating signal.

As shown in FIG. 1, the driving unit 110 may include a preprocessing unit 101, a lane searching unit 103, a lane tracking unit 105 and a warning generating unit 107.

The preprocessing unit 101 receives the image data from the image photographing unit 150 (S100) and selects an ROI (Region Of Interest) from the image data to group a plurality of regions, which are determined as one lane, by searching for a lane in the ROI (S200).

The lane searching unit 103 detects a lane pair, which is two lines constituting one lane, from the grouped region and then detects the optimum lane pair among the detected lane pairs (S400).

The lane tracking unit 105 is selectively driven with the lane searching unit 103. When the lane pairs are detected through several frames by the lane searching unit 103 (S300), the lane tracking unit 105 detects the optimum lane pair from the ROI reduced on the basis of the detected lane pair (S500).

Thus, when the lane tracking of the lane tracking unit 105 succeeds (S600), the warning generating unit 107 generates the warning generating signal (S700). To the contrary, when the lane tracking unit 105 fails to track the lane, the lane searching unit 103 performs the step of tracking a lane again.

After the warning generating unit 107 receives the information about the optimum lane from the lane searching unit 103 or the lane tracking unit 105, the warning generating unit 107 calculates the lateral distance according to the relation between the lane and the vehicle, and then, calculates the elapsed time of a lane change based on the lateral speed. When the calculated time is in the predetermined range, the warning generating unit 107 outputs the warning generating signal.

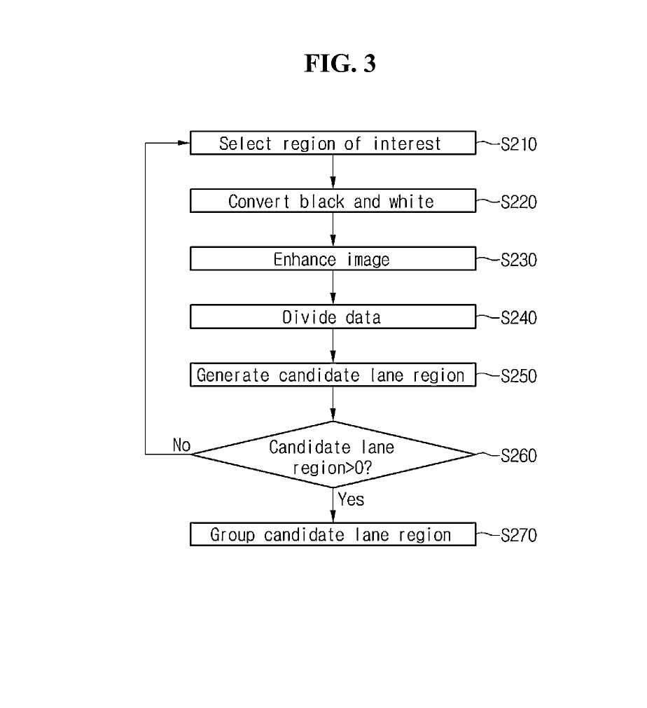

Hereinafter, the respective steps will be described with reference to FIGS. 3 to 8 in detail.

First, as shown in FIG. 3, when the image photographing unit 150 photographs an image of an object in a forward direction of the vehicle, the preprocessing unit 101 receives the image of the object to perform the preprocessing.

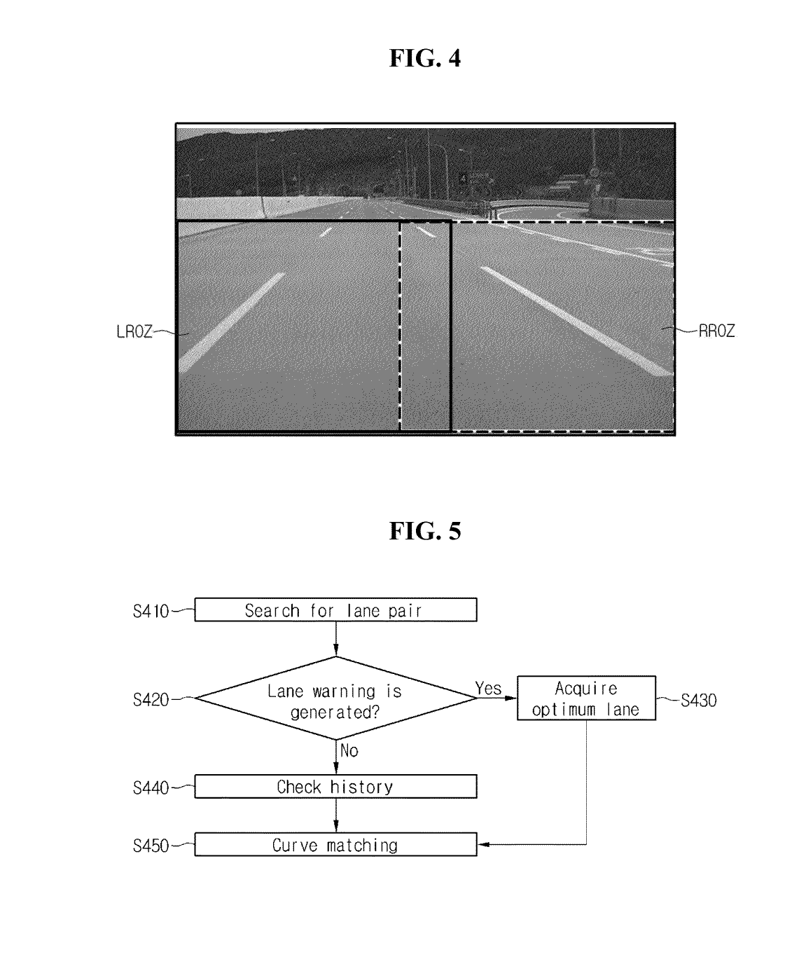

That is, the ROI is set in the image as shown in FIG. 4, and the set ROI is selected (S210). In this case, the ROI may include a left ROI having a predetermined area ranging from a left peripheral region of the image and a right ROI having a predetermined area ranging from a right peripheral region of the image.

An area of the ROI may be variously set, and the left ROI and the right ROI may be partially overlapped with each other at centers thereof as shown in FIG. 4. In this manner, since the left ROI and the right ROI are partially overlapped with each other, the ROI may include all lanes for the vehicle.

Next, the image of the ROI is converted to have a black and white color (S220). That is, the data size may be reduced by converting RGB data into black and white data (S220).

After that, the preprocessing unit 101 reinforces an image (S230).

In the image reinforcement step, the preprocessing unit 101 increases a contrast ratio by adjusting intensity of illumination. The image reinforcement may be performed by a Constant Limited Adaptive Histogram Equalization (CLAHE) algorithm. Accordingly, a feature of a hidden image may be highlighted.

Subsequently, data segmentation is performed (S240).

The data segmentation is performed by filtering extracting pixels constituting the lane from the reinforced data.

That is, the filtering is performed according to a data application value in each pixel while moving a mask having a predetermined size in the ROI. For example, when an average of data of a plurality of pixels in [(x-mask);x, y] with respect to a point (x, y) is Ileft, and an average of data of a plurality of pixels in [(x+mask);x, y] with respect to a point (x, y) is Iright, a pixel satisfying a following relation equation 1 is selected as a lane pixel.

D(x, y)>Ileft+Dth and D(x, y)>Iright+Dth [Relation equation 1]

The Dth may be optionally set.

Further, the size of the mask is gradually increased is along a vertical axis of an image so that the perspective may be reflected, but the embodiment is not limited thereto. That is, the size of the mask may flexibly vary.

Next, a candidate lane region is generated by grouping some of the lane pixels (S250).

In this case, the candidate lane region may be generated by grouping the lane pixels according to a size, a boundary point, a main axis, a sub-axis, and a region gradient.

Next, it is determined whether the candidate lane region is generated (S260). When the candidate lane region is generated, a part of the candidate lane regions is grouped (S270).

In this case, the grouping of the candidate lane regions may be performed according to the gradient, but the embodiment is not limited thereto. That is, the candidate lane regions may be grouped by reflecting other features.

That is, a plurality of candidate lane regions constituting one lane are recognized as the one lane and grouped as one candidate lane group. A gradient of the generated group and lower and upper intersection points of the generated group may be stored in a flag as features.

In this case, the image reinforcement step may be omitted or be variously set.

In this manner, if the candidate lane group is formed, the image preprocessing step is terminated.

The following is a description of a lane searching step.

If a lane pair exists in a previous frame after the preprocessing unit 101 terminates grouping the lane regions, a lane tracking step is performed. When no lane pair exists in the previous frame, a lane searching step is performed.

The lane searching step is described with reference to FIG. 5.

First, the lane searching unit 103 searches lane pairs (S410).

The search for the lane pairs is performed by extracting two lanes determined as a pair by comparing features of left and right candidate lane groups with each other.

In this case, when a lane is changed in a previous frame (S420), a currently searched lane pair is determined as an optimal lane pair (S430).

When the lane is not changed, a history of the searched lane pair is checked (S440). In the history check, currently searched lane pairs are compared with previously searched lane pairs, and a lane pair of the currently searched lane pairs matching with the previous lane pairs within a threshold range is determined as an optimal lane pair.

In this case, the compared value may include a gradient and an intersection point, and may selectively include additional features.

If the optimal line pair is determined, a curved or straight parameter is calculated and stored (S450).

The curved or straight parameter may be used in a lane tracking step.

In this manner, if the optimal lane pair in the current frame is determined, the lane searching step is terminated.

Meanwhile, an operation of the lane tracking unit 105 starts after one lane pair is searched from the lane searching unit 103.

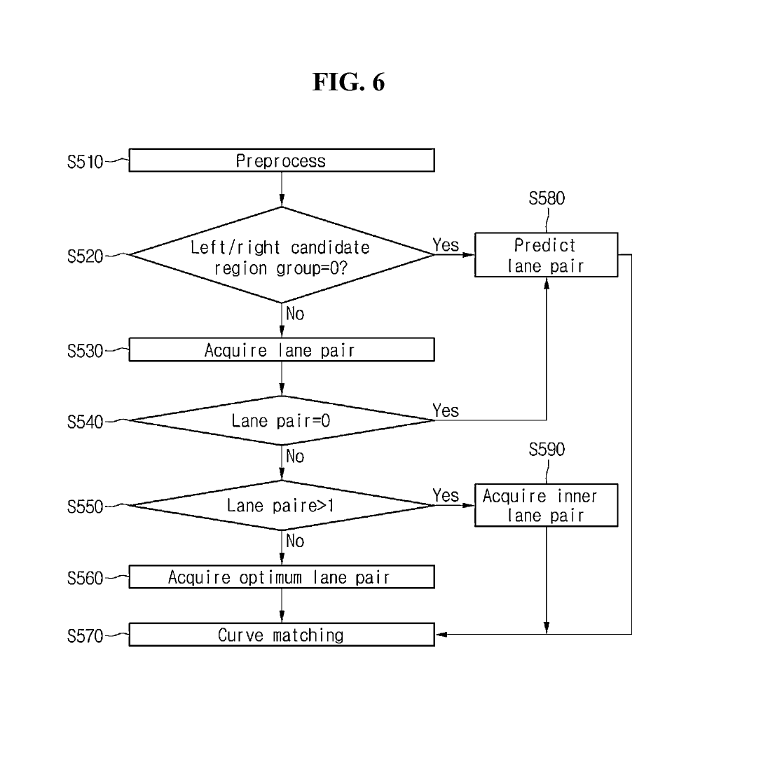

Referring to FIG. 6, if the lane tracking starts, an ROI region of the preprocessing unit 101 has a reduced shape including surroundings of each searched lane pair without including full images in the horizontal direction as shown in FIG. 4.

The preprocessing operation including black and white conversion, image reinforcement, data division, extraction of candidate lane regions, and grouping of candidate lane regions with respect to the reduced ROI are sequentially performed (S510).

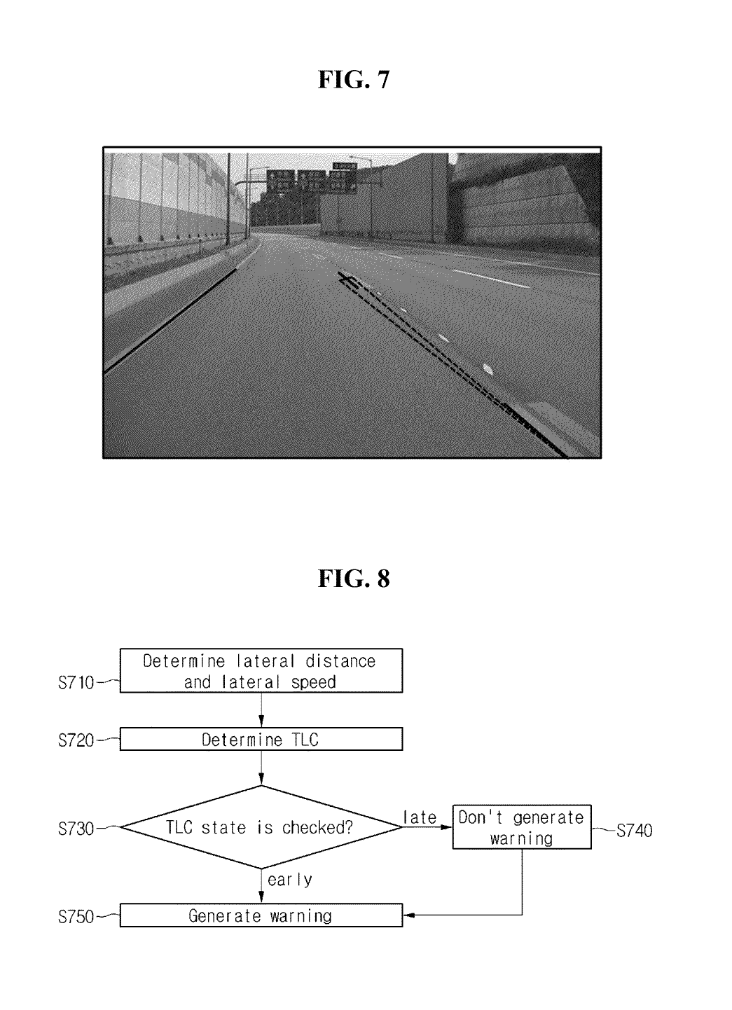

Accordingly, the grouped candidate region has a similar gradient within a threshold value as shown in FIG. 7.

Next, when a left candidate region group and a right candidate region group exist (S520), a lane pair is obtained from the candidate region group (S530).

A procedure of obtaining the lane pair is the same as the procedure of obtaining the lane pair in the lane searching procedure.

In this case, the number of the acquired lane pairs is determined (S550). When the number of the acquired lane pairs exceeds 1, an inner lane pair is determined as an optimal lane pair (S590).

In this manner, if the optimal lane pair is determined (S560), curvature matching with respect to the optimal lane pair is performed so that data are stored (S570).

Meanwhile, when both the left candidate region group and the right candidate region group do not exist, the lane pair is estimated (S580).

In the estimation of the line pair, a feature of the estimated lane pair is compared with a feature of a reference lane pair detected in a previous frame to select a lane from an adjacent left or right candidate region group.

In this case, the features of determining the lane may include a gradient and an intersection point. In this manner, the estimated lane pair is determined as an optimal lane pair and the curvature matching with respect to the optimal lane pair is performed so that data are stored.

In this manner, if the optimal lane pair is determined through the lane searching procedure or the lane tracking procedure, a warning generating step is performed.

The warning generating unit 107 determines presence of warning based on vehicle speed and a location of the vehicle from the lane pair.

First, the warning generating unit 107 determines a current location of the vehicle from the line pair to calculate a lateral distance between the lane pair and the vehicle, and to calculate lateral speed of the vehicle (S710).

Next, the warning generating unit 107 calculates a TLC (S720).

The TLC satisfies a following equation 1.

TLC=D/lateral speed [Equation 1]

The TLC is a time taken by a current vehicle to reach a corresponding lane pair, that is, a time taken by the vehicle to depart from a current lane.

Next, when the TLC is equal to or greater than a threshold time (S730), the warning generating unit 107 outputs a warning generating signal (S750). To the contrary, if the TLC is less the threshold time, the warning generating unit 107 determines that the lane departure occurs so the warning generating signal is not generated (S740). The threshold time is a time taken to stop the vehicle running in the current speed and may vary according to the current speed.

In this manner, if the driving unit 110 generates the warning generating signal and transmits the warning generating signal to the warning unit 160, the warning unit 160 audibly and visibly provides warning to a driver.

Although a preferred embodiment of the disclosure has been described for illustrative purposes, those skilled in the art will appreciate that various modifications, additions and substitutions are possible, without departing from the scope and spirit of the invention as disclosed in the accompanying claims.

What is claimed is:

1. A lane departure warning system comprising:
an image photographing unit attached to a front of a vehicle to photograph an object in a forward direction of the vehicle;
a driving unit that receives image data from the image photographing unit to search for a lane pair by filtering the image data using a predetermined mask, and calculates a time of lane change from the lane pair to the vehicle to generate a warning generating signal; and
a warning unit receiving the warning generating signal to generate a lane departure warning signal.

2. The lane departure warning system of claim 1, wherein the driving unit comprises:
a preprocessing unit filtering the image data to extract candidate lane regions, and grouping the candidate lane regions based on features of the extracted candidate lane regions;
a lane searching unit searching for a lane pair from the grouped candidate lane regions from the preprocessing unit; and
a warning generating unit to calculate the time of lane change between the lane and the vehicle based on the lane pair in order to generate the warning generating signal.

3. The lane departure warning system of claim 2, wherein the driving unit further includes a lane tracking unit to track a current lane pair based on the lane pair of previous image data.

4. The lane departure warning system of claim 3, wherein the preprocessing unit selects a region of interest having a predetermined size from the image data to process data of the selected region of interest.

5. The lane departure warning system of claim 4, wherein the preprocessing unit places the mask to a left and a right of a corresponding pixel of pixels in the region of interest to extract pixels in the mask as the candidate lane region when the pixels have an average data value greater than a threshold value.

6. The lane departure warning system of claim 5, wherein a size of the mask is variable.

7. The lane departure warning system of claim 6, wherein the size of the mask is increased along a vertical axis of the region of interest.

8. The lane departure warning system of claim 2, wherein the preprocessing unit compares a gradient, a bottom intersection point and a top intersection point of the candidate lane region with each other to group a plurality of candidate lane regions.

9. The lane departure warning system of claim 4, wherein the preprocessing unit enhances the image data in the region of interest to emphasize the feature.

10. The lane departure warning system of claim 9, wherein the enhancement of the image data is performed by applying a CLAHE algorithm.

11. The lane departure warning system of claim 2, wherein the lane searching unit acquires the lane pair by searching for the lane pair, and calculates a curvature of the lane pair to store curve data.

12. The lane departure warning system of claim 2, wherein the lane tracking unit acquires the lane pair by estimating the lane pair when the lane region group does not exist.

13. A lane departure warning method comprising:
photographing an object in a forward direction of a vehicle to generate image data;
selecting a lane region group by dividing the image data using a predetermined mask and filtering the divided image data;
searching for a lane pair in the lane region group;
tracking the lane pair in a current frame based on the lane pair when the lane pair exists in the lane region group; and
generating a warning signal according to a time of lane change by calculating the time of lane change from the lane pair to the vehicle.

14. The lane departure warning method of claim 13, wherein the selecting of the lane region group includes:
selecting a region of interest having a predetermined size from the image data;
extracting pixels having an average data value greater than a threshold value in the mask as the candidate lane region by placing the mask to a left and a right of a corresponding pixel of pixels in the region of interest; and
generating the lane region group by grouping the candidate lane region based on a feature of the candidate lane region.

15. The lane departure warning method of claim 14, wherein the feature of the candidate lane region includes a gradient, a bottom intersection point and a top intersection point.

16. The lane departure warning method of claim 13, wherein the candidate lane region is generated by varying a size of the mask.

17. The lane departure warning method of claim 13, wherein the extracting of the candidate lane region further includes enhancing the image data of the region of interest.

18. The lane departure warning method of claim 13, wherein the searching of the lane pair includes:
selecting the lane pair by comparing information about features of the lane region group with each other;
acquiring the lane pair by comparing the selected lane pairs with lane pairs of previous frames; and
storing curve data by calculating a curvature of the lane pair.

19. The lane departure warning method of claim 13, wherein the tracking of the lane pair includes acquiring the lane pair by estimating the lane pair when the lane region group does not exist.

20. The lane departure warning method of claim 13, where the region of interest in the tracking of the lane pair has a size less than a size of the region of interest in the searching of the lane pair.
